(19) United States
(12) Patent Application Publication
(10) Pub. No.: US 2014/0195696 A1
(43) Pub. Date: Jul. 10, 2014

(54) INFORMATION PROCESSING DEVICE, INFORMATION PROCESSING METHOD, AND INFORMATION PROCESSING SYSTEM

(71) Applicant: SONY CORPORATION, Tokyo (JP)

(72) Inventors: SEIJI MIYAMA, Kanagawa (JP); NORIFUMI KIKKAWA, Tokyo (JP)

(73) Assignee: SONY CORPORATION, Tokyo (JP)

(21) Appl. No.: 14/079,418

(22) Filed: Nov. 13, 2013

(30) Foreign Application Priority Data
Jan. 9, 2013 (JP) 2013-001770

(51) Int. Cl. H04L 45/749

(52) U.S. Cl. CPC H04L 45/741
USPC 709/242

(57) ABSTRACT

There is provided an information processing device including a communication unit that transmits a domain name of a server belonging to a first network, and receives, from a mapping device that maps an IP address on a first network corresponding to the domain name to an IP address on a second network, an IP address on the second network that corresponds to the domain name, an estimator that, from the IP address on the second network received by the communication unit and the IP address on the first network of the server, estimates a mapping rule that maps an IP address on the first network to an IP address on the second network, and a generator that, on the basis of an estimated mapping rule, generates an IP address on the second network from an arbitrary IP address on the first network.

### CROSS REFERENCE TO RELATED APPLICATION(S)

This application claims the benefit of Japanese Priority Patent Application JP 2013-001770 filed Jan. 9, 2013, the entire content of which is incorporated herein by reference.

### BACKGROUND

The present disclosure relates to an information processing device, an information processing method, and an information processing system.

In the related art, such as in Japanese Unexamined Patent Application Publication No. 2004-363745, for example, there is described technology envisioned to enable smooth communication between peers executing different communication protocols such as IPv4 and IPv6 in a P2P application.

### SUMMARY

However, with the technology described in Japanese Unexamined Patent Application Publication No. 2004-363745, in a hybrid P2P in which a P2P server exists, P2P communication between IPv6/IPv4 equipment is realized by placing the P2P server as a dual stack compatible with IPv6/IPv4, with the P2P server controlling a DNS-ALG (DNS proxy) and NAT-PT (translator). For this reason, the system topology becomes complicated, producing a problem in that P2P communication between equipment on a first network (IPv4) and a second network (IPv6) becomes costly.

Accordingly, there is demand to realize P2P communication that, with a simple topology, acquires a mapping rule from an IP address on a first network to an IP address on a second network.

According to an embodiment of the present disclosure, there is provided an information processing device including a communication unit that transmits a domain name of a server belonging to a first network, and receives, from a mapping device that maps an IP address on a first network corresponding to the domain name to an IP address on a second network, an IP address on the second network that corresponds to the domain name, an estimator that, from the IP address on the second network received by the communication unit and the IP address on the first network of the server, estimates a mapping rule that maps an IP address on the first network to an IP address on the second network, and a generator that, on the basis of an estimated mapping rule, generates an IP address on the second network from an arbitrary IP address on the first network.

The IP address on the first network of the server may be preregistered before product shipment.

The IP address on the first network of the server may be reported from the server via a translator.

The IP address on the first network of the server may be preregistered by being conveyed by an operator related to the server.

The communication unit may transmit the domain name multiple times, and receives an IP address on the second network corresponding to the domain name multiple times, and the estimator may estimate the mapping rule from the IP address on the second network received by the communication unit multiple times, and the IP address on the first network of the server.

The communication unit may transmit domain names of a plurality of servers belonging to a first network, and plurally receives an IP address on the second network corresponding to the domain names of the plurality of servers, and the estimator may estimate the mapping rule from the IP address on the second network plurally received by the communication unit, and the respective IP addresses on the first network of the plurality of servers.

The estimator may estimate the mapping rule in a case of sensing that the information processing device possesses only an IP address on the second network.

The estimator may estimate the mapping rule when communicating with equipment on a first network.

The communication unit may use the IP address on the second network generated by the generator to conduct P2P communication with equipment on the first network.

The information processing device may further include a recording unit that records the mapping rule.

According to an embodiment of the present disclosure, there is provided an information processing method including transmitting a domain name of a server belonging to a first network, receiving, from a mapping device that maps an IP address on a first network corresponding to the domain name to an IP address on a second network, an IP address on the second network that corresponds to the domain name, estimating, from the received IP address on the second network and the IP address on the first network of the server, a mapping rule that maps an IP address on the first network to an IP address on the second network, and generating, on the basis of an estimated mapping rule, an IP address on the second network from an arbitrary IP address on the first network.

According to an embodiment of the present disclosure, there is provided an information processing system including a first device provided with an estimator that acquires an IP address in which an IP address on a first network corresponding to a domain name of a server belonging to a first network has been mapped to an IP address on a second network, and estimates, from the acquired IP address and the IP address on the first network of the server, a mapping rule that maps an IP address on the first network to an IP address on the second network, and a second device provided with a generator that, on the basis of a mapping rule estimated by the first device, generates an IP address on the second network from an arbitrary IP address on the first network.

According to the present disclosure, it becomes possible to realize P2P communication between a first network and a second network with a simple topology.

### BRIEF DESCRIPTION OF THE DRAWINGS

FIG. 1A is a schematic diagram for explaining technology presupposed by the present disclosure;

FIG. 1B is a schematic diagram for explaining technology presupposed by the present disclosure;

FIG. 2 is a schematic diagram for explaining a mapping rule estimation method according to an embodiment of the present disclosure;

FIG. 3 is a schematic diagram for explaining a mapping rule estimation method according to an embodiment of the present disclosure;

FIG. 4 is a schematic diagram for explaining a mapping rule estimation method according to an embodiment of the present disclosure;

FIG. 5 is a schematic diagram for explaining an automatic map address generation method according to an embodiment of the present disclosure;

FIG. 6 is a schematic diagram for explaining a configuration of IPv6 equipment;

FIG. 7 is a flowchart illustrating a mapping rule estimating process;

FIG. 8 is a flowchart illustrating a process for the case of IPv6 equipment conducting P2P communication with IPv4 equipment; and

FIG. 9 is a schematic diagram illustrating an example of UDP hole punching.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, the description will proceed in the following order:

1. Presupposed technology

2. Mapping rule estimation method according to present embodiment

3. Automatic map address generation method according to present embodiment

4. Exemplary configuration of IPv6 equipment according to present embodiment

5. Process flow of IPv6 equipment according to present embodiment

6. Modifications of present embodiment

7. Application to UDP (or TCP) hole punching

[1. Presupposed Technology]

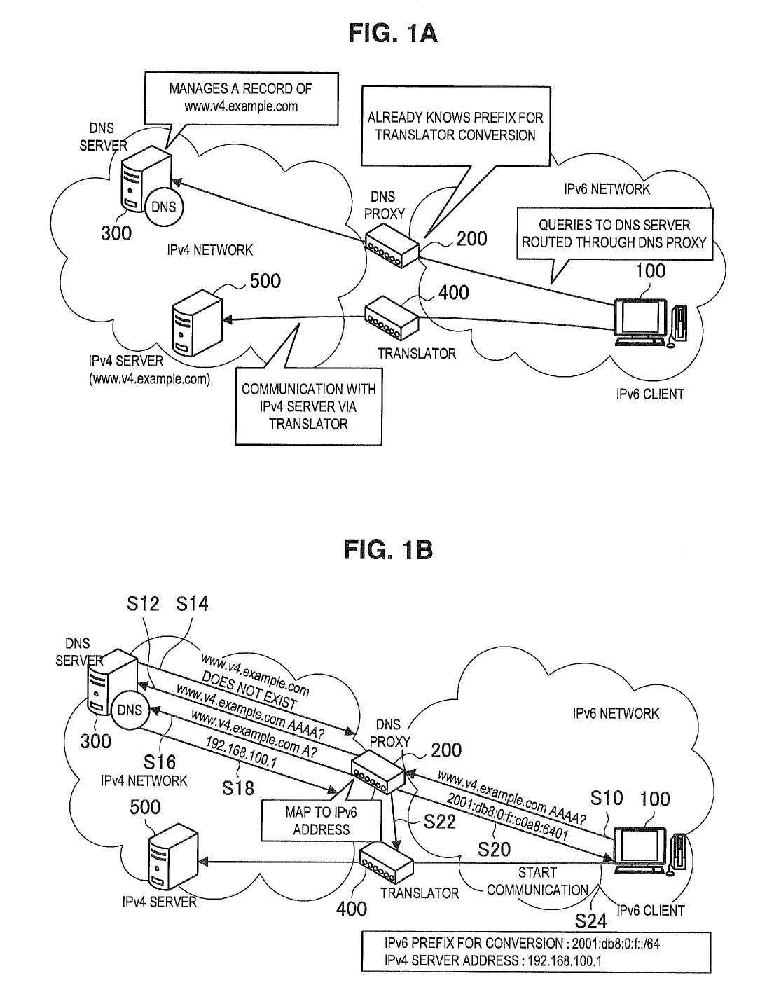

First, technology presupposed by the present disclosure will be described with reference to FIG. 1. FIGS. 1A and 1B are schematic diagrams illustrating an example in which an IPv6 client 100 on an IPv6 network connects to an IPv4 server on an IPv4 network. As illustrated in FIG. 1A, in the case where an IPv6 client possessing only an IPv6 address connects to an IPv4 server possessing an IPv4 address, an IPv6/IPv4 translator and DNS proxy are generally used.

As illustrated in FIG. 1B, first, in steps S10 and S12, an FQDN (www.v4.example.com.AAAA) is queried from the IPv6 client 100 via a DNS proxy 200. In step S14, a DNS server 300 receiving the query reports to the DNS proxy 200 that an FQDN (www.v4.example.com) does not exist.

Next, in step S16 the DNS proxy 200 queries the DNS server 300 for an IPv4 address. In step S18, the DNS server 300 transmits an IPv4 address (192.168.100.1) to the DNS proxy 200. The DNS proxy 200 maps the IPv4 address (192.168.100.1) to an IPv6 address according to a designated mapping rule, and in step S20, transmits the mapped IPv6 address (2001:db8:0:f::c0a8:6401) to the IPv6 client 100.

In step S22, the DNS proxy 200 registers the mapping rule of an IPv4 address to an IPv6 address in an IPv6/IPv4 translator 400. In step S24, if communication from the IPv6 client 100 to an IPv4 server 500 starts, the IPv6/IPv4 translator 400 converts the IPv6 address to an IPv4 address, and communicates with the IPv4 server 500.

As above, in the case where an IPv6 client 100 possessing only an IPv6 address connects to an IPv4 server 500 possessing an IPv4 address, connection becomes possible by registering an address conversion rule in an IPv6/IPv4 translator 400.

However, in the case of P2P communication in which IP addresses are directly exchanged in the application layer, a query from the IPv6 client 100 to the DNS proxy 200 is not produced. For this reason, conversion to an IPv6 address for use in the case where the IPv6 client 100 connects using the IPv6/IPv4 translator 400 is not conducted, and as a result, communication fails. Meanwhile, the case of using DDNS involves all equipment wanting to conduct P2P communication acquiring an FQDN, which increases costs.

Accordingly in the present embodiment, IPv6 equipment acquires the FQDN of a server possessing an IPv4 address in advance, which is then utilized to estimate the mapping rule of the DNS proxy 200. When IPv6 equipment acquires the IP address of IPv4 equipment and starts P2P communication, an IPv6 address is automatically generated from the estimated mapping rule, thereby enabling P2P communication with the IPv4 equipment. Details are described below.

[2. Mapping Rule Estimation Method According to Present Embodiment]

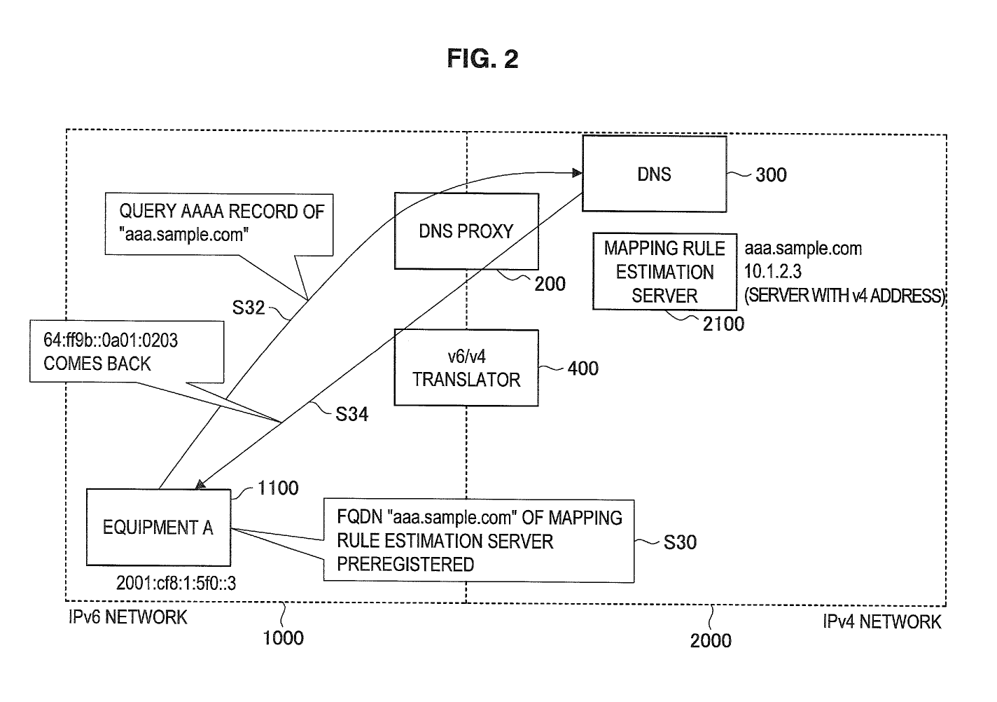

FIGS. 2 to 5 are schematic diagrams illustrating a configuration of a system according to the present embodiment. As illustrated in FIG. 2, the present system includes an IPv6 network 1000 and an IPv4 network 2000. IPv6 equipment 1100 belongs to the IPv6 network 1000. The IPv6 address of the IPv6 equipment 1100 is (2001:cf8:1:5f0::3). A DNS server 300 and a mapping rule estimation server 2100 belong to the IPv4 network 2000.

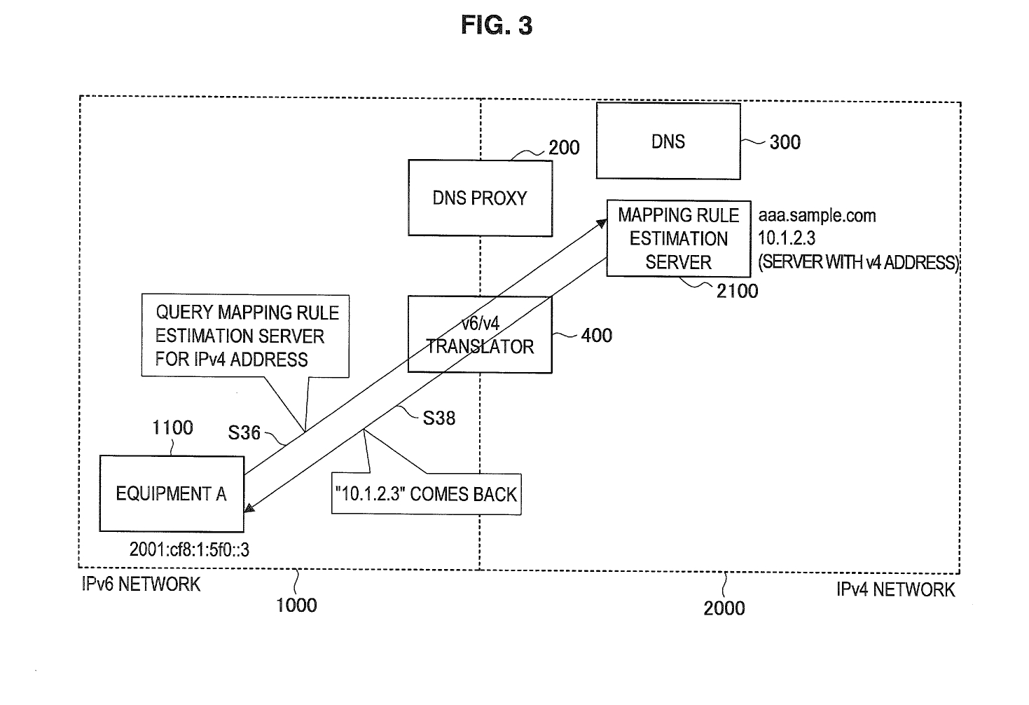

First, a technique by which the IPv6 equipment 1100 estimates the prefix of an IPv6 address will be described on the basis of FIGS. 2 and 3. A prefix is added to the leading part of an IPv6 address, and in the example of FIG. 1B, corresponds to “2001:db8:0:f::”.

As illustrated in FIG. 2, an FQDN (aaa.sample.com) is preregistered in the IPv6 equipment 1100 as the domain name of the mapping rule estimation server 2100 (step S30). Next, in step S32 the IPv6 equipment 1100 queries the DNS server 300 for the AAAA record of (aaa.sample.com). Next, in step S34 the DNS server 300 replies to the IPv6 equipment 1100 with the AAAA record (64:ff9b::0a01:0203) of (aaa.sample.com) of the mapping rule estimation server 2100, or in other words, with an IPv6 address.

Next, as illustrated in FIG. 3, in step S36 the IPv6 equipment 1100 queries the mapping rule estimation server 2100 for an IPv4 address. In step S38, the mapping rule estimation server 2100 replies to the IPv6 equipment 1100 with (10.1.2.3) as the IPv4 address. Although also explained in the modifications discussed later, note that the IPv4 address query may also use another method. For example, it is also possible to register the IPv4 address (10.1.2.3) in the IPv6 equipment 1100 by having the owner (operator) of the mapping rule estimation server 2100 inform the owner of the IPv6 equipment 1100 of the IPv4 address (10.1.2.3) by another method such as verbally.

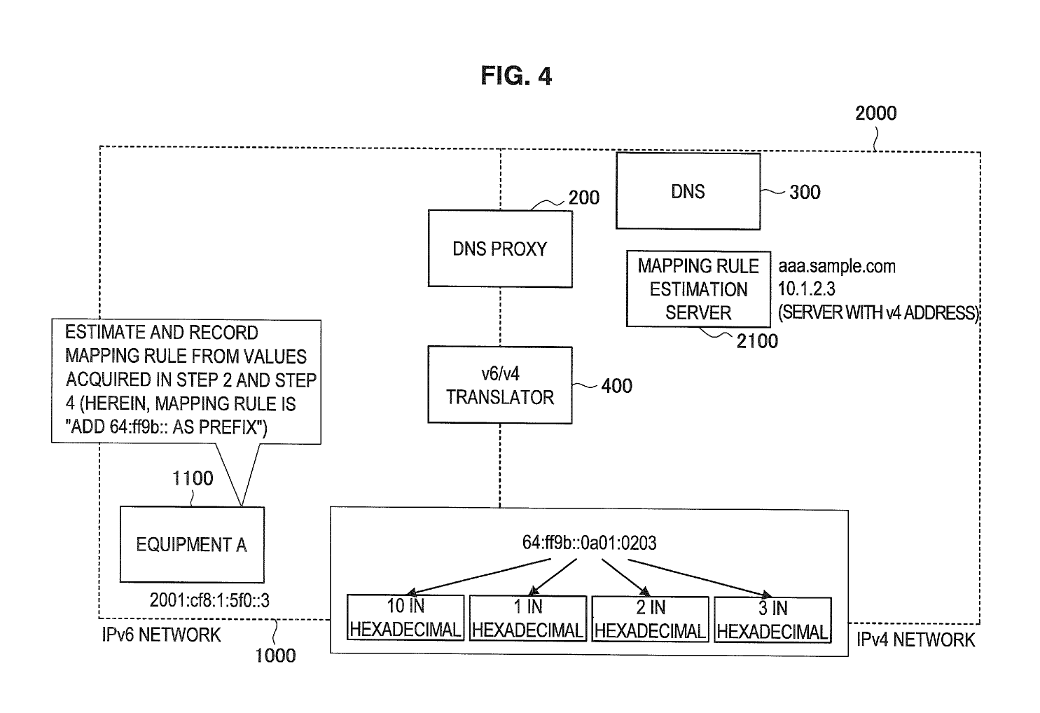

Next, as illustrated in FIG. 4, in step S40 the IPv6 equipment 1100 estimates and records a mapping rule by comparing (64:ff9b::0a01:0203) acquired in step S34 to (10.1.2.3) acquired in step S38. At this point, as illustrated in FIG. 4, “0a01:0203” from the IPv6 address (64:ff9b::0a01:0203) corresponds to the IPv4 address (10.1.2.3) in hexadecimal (0a01:0203=10.1.2.3 (0a (hex)=10 (dec), 01 (hex)=1 (dec), 02 (hex)=2 (dec), 03 (hex)=3 (dec))). Consequently, the IPv6 equipment 1100 estimates and records that the prefix is “64:ff9b::”. Also, the IPv6 equipment 1100 estimates and records that “0a01:0203” from the IPv6 address corresponds to the IPv4 address (10.1.2.3).

In so doing as above, the IPv6 equipment 1100 is able to estimate a mapping rule by comparing the AAAA record of (aaa.sample.com) to an acquired IPv4 address.

[3. Automatic Map Address Generation Method According to Present Embodiment]

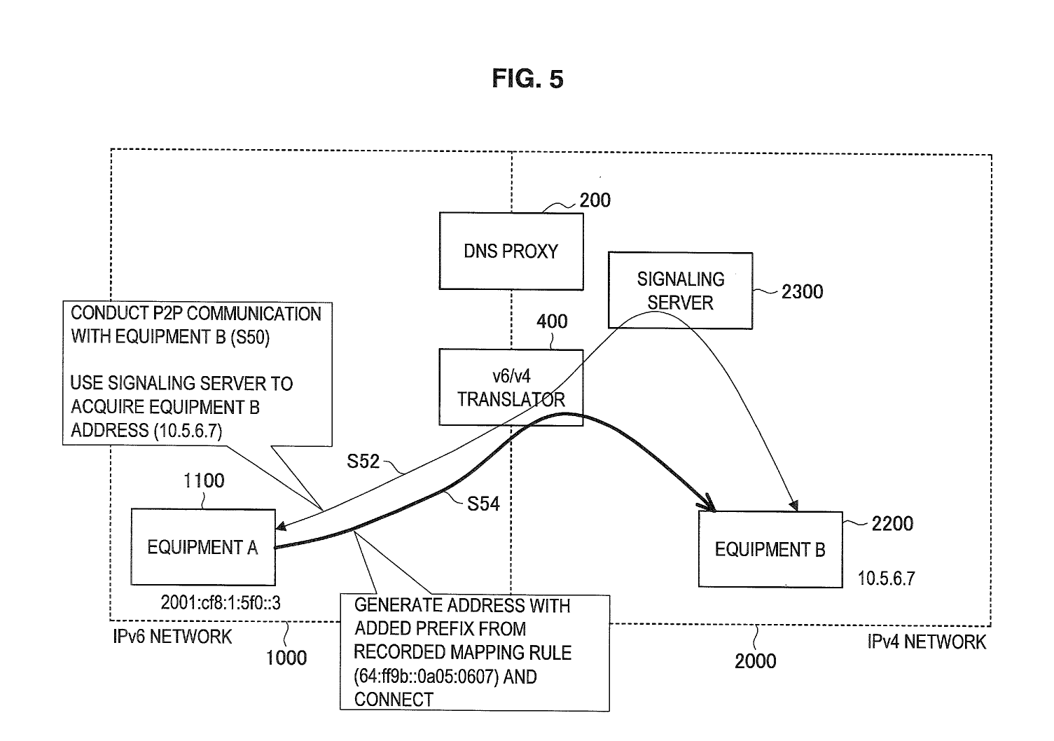

Next, a case in which the IPv6 equipment 1100 conducts P2P communication with IPv4 equipment 2200 belonging to the IPv4 network 2000 will be described on the basis of FIG. 5. First, in step S50 the IPv6 equipment 1100 determines to conduct P2P communication with the IPv4 equipment 2200, and uses a P2P communication signaling server 2300 to acquire the IPv4 address (10.5.6.7) of the IPv4 equipment 2200.

Next, in step S54 the IPv6 equipment 1100 uses a mapping rule estimated and recorded according to the process in FIGS. 2 to 4 to generate an IPv6 address (64:ff9b::0a05:0607) with a prefix added to the IPv4 address (10.5.6.7), and uses this IPv6 address (64:ff9b::0a05:0607) to connect to the IPv4 equipment 2200. Herein, “0a05:0607” from the IPv6 address corresponds to the IPv4 address (10.5.6.7) in hexadecimal.

As above, the IPv6 equipment 1100 is able to generate an IPv6 address with an added prefix from the IPv4 address of the IPv4 equipment 2200, on the basis of an estimated mapping rule. Consequently, the IPv6 equipment 1100 becomes able to conduct P2P communication with the IPv4 equipment 2200.

[4. Exemplary Configuration of IPv6 Equipment According to Present Embodiment]

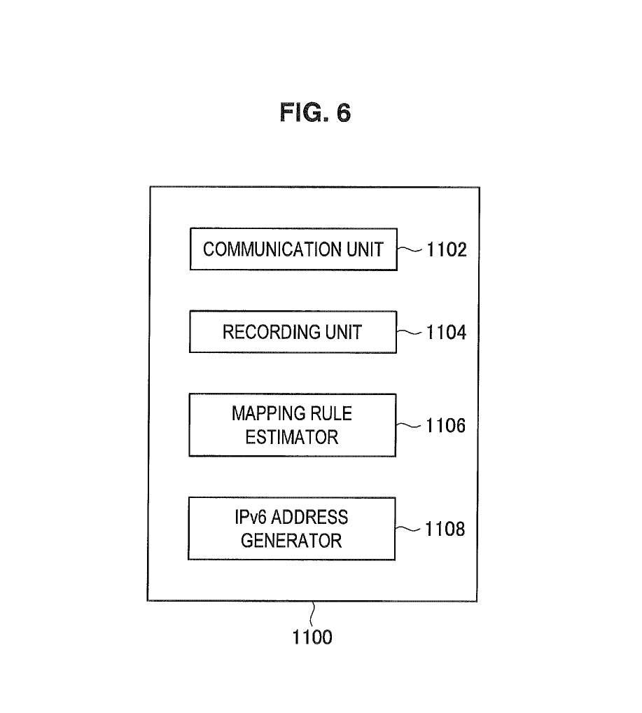

Next, a configuration of the IPv6 equipment 1100 will be described on the basis of FIG. 6. As illustrated in FIG. 6, the IPv6 equipment 1100 includes a communication unit 1102, a recording unit 1104, a mapping rule estimator 1106, and an IPv6 address generator 1108. The communication unit 1102 communicates with the IPv4 equipment 2200 via the IPv6/IPv4 translator 400. The recording unit 1104 is memory that records an estimated mapping rule. The mapping rule estimator 1106 estimates a mapping rule. The IPv6 address generator 1108 generates an IPv6 address on the basis of an estimated mapping rule.

The configuration of the IPv6 equipment 1100 illustrated in FIG. 6 may be realized by hardware, or by a processor such as a CPU and software (a program) causing such a processor to function. In this case, the program may be stored in memory provided in the IPv6 equipment 1100, or an externally connected recording medium or the like.

[5. Process Flow of IPv6 Equipment According to Present Embodiment]

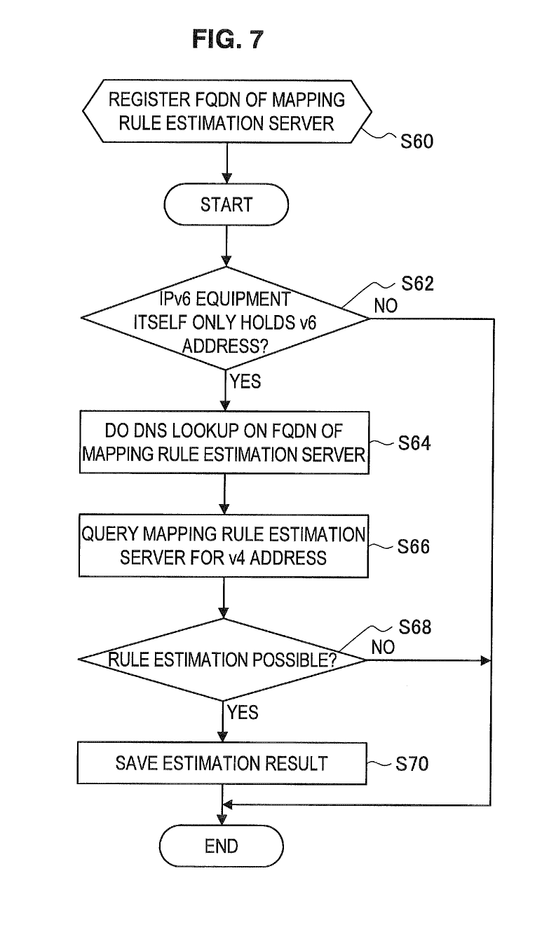

Next, a process flow of the IPv6 equipment 1100 will be described. FIG. 7 is a flowchart illustrating a mapping rule estimating process. First, presuppose that the FQDN (aaa.sample.com) of the mapping rule estimation server 2100 has been registered in the IPv6 equipment 1100 in advance (step S60).

In step S62, it is determined whether the IPv6 equipment 1100 holds an IPv6 address only. Then, in the case of holding an IPv6 address only, it is determined that a mapping rule for adding a prefix will be estimated when conducting P2P communication with the IPv4 equipment 2200. In the next step S64, the IPv6 equipment 1100 performs a DNS lookup with respect to the DNS proxy 200 in order to resolve an IP address from the FQDN of the mapping rule estimation server 2100. Similarly to FIG. 1B, the DNS proxy 200 replies to the IPv6 equipment 1100 with an IPv6 address (64:ff9b::0a05:0607) in which a prefix is added to the IPv4 address. Herein, as discussed earlier, 0a01:0203=10.1.2.3 (0a (hex)=10 (dec), 01 (hex)=1 (dec), 02 (hex)=2 (dec), 03 (hex)=3 (dec)).

In the next step S66, the IPv6 equipment 1100 queries the mapping rule estimation server 2100 (64:ff9b::0a05:0203, corresponding to aaa.sample.com) for an IPv4 address. In response, the mapping rule estimation server 2100 replies to the IPv6 equipment 1100 with an IPv4 address (10.1.2.3).

In the next step S68, the IPv6 equipment 1100 determines whether mapping rule estimation is possible. In the case where mapping rule estimation is possible, the IPv6 equipment 1100 proceeds to step S70, estimates a mapping rule for the IPv6 address in the network environment, and records the estimated mapping rule in the recording unit 1104. Herein, the prefix is “64:ff9b::”, and a mapping rule that appends the IPv4 address (10.1.2.3) as the hexadecimal “001:0203” is estimated.

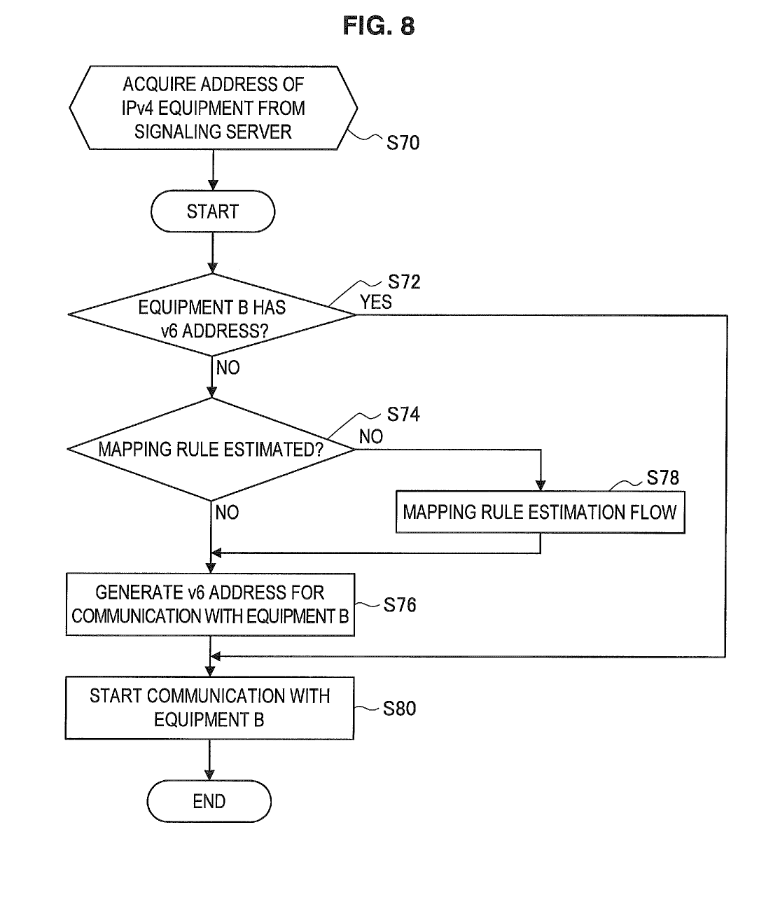

FIG. 8 is a flowchart illustrating a process for the case of the IPv6 equipment 1100 conducting P2P communication with the IPv4 equipment 2200. First, presuppose that the IPv6 equipment 1100 acquires the IPv4 address of communication peer (that is, the IPv4 equipment 2200) via the intermediation of the signaling server 2300 (step S70).

When the process starts, first, in step S72 the IPv6 equipment 1100 determines whether or not the address acquired in step S270 is an IPv6 address. At this point, assume that the address of the IPv4 equipment 2200 is an IPv4 address (10.5.6.7).

In this case, since the address of the IPv4 equipment 2200 is an IPv4 address, the IPv6 equipment 1100 proceeds to the next step S74 and determines whether or not a mapping rule has been estimated. In the case where a mapping rule has been estimated, the IPv6 equipment 1100 proceeds to the next step S76. On the other hand, in the case where a mapping rule has not been estimated, the IPv6 equipment 1100 proceeds to step S78, conducts the mapping rule estimation described in FIG. 7, and proceeds to step S76.

In step S76, an IPv6 address (64:ff9b::0a05:0607) is generated from the IPv4 address (10.5.6.7) on the basis of the mapping rule acquired by the process in FIG. 7. In the next step S80, the IPv6 equipment 1100 starts a connection with the IPv6 address (64:ff9b::0a05:0607) generated in step S76. Also, in step S72, in the case where the peer equipment for P2P communication has an IPv6 IP address, the acquired IPv6 address is used to connect to the communication peer equipment. After step S80, the process ends.

[6. Modifications of Present Embodiment]

Hereinafter, modifications of the foregoing embodiment will be described. Although also described in the foregoing embodiment, the IPv6 equipment 1100 may hold the IPv4 address of the mapping rule estimation server 2100 in advance. For example, the IPv4 address of the mapping rule estimation server 2100 may be preregistered in the recording unit 1104 before product shipment of the IPv6 equipment 1100. In this case, rather than running the mapping rule estimation server 2100, the FQDN for mapping rule estimation (aaa.sample.com) and the IPv4 address “10.1.2.3” may be registered in the DNS server 300, and it is sufficient for the IPv6 equipment 1100 to acquire the FQDN (aaa.sample.com) and the IPv4 address (10.1.2.3) in advance. In this case, since the mapping rule estimation server 2100 is not queried for an IPv4 address, the mapping rule estimation server 2100 may also not be running as a device.

Also, in the present embodiment, two types of processes are conducted: a “mapping rule estimation” (FIG. 7) and “address generation” (FIG. 8) utilizing an estimated mapping rule. Although both processes are conducted by the IPv6 equipment 1100 in the foregoing embodiment, it is also possible for another device to conduct these processes.

For example, mapping rule estimation may also be conducted at the mapping rule estimation server 2100. In this case, the IPv6 equipment 1100 reports to the mapping rule estimation server 2100 that the IPv6 address of (aaa.sample.com) resolved to 64:ff9b::0a01:0203, and the mapping rule estimation server 2100 estimates a rule. The mapping rule estimation server 2100 is holding its own IPv4 address (10.1.2.3), and thus is able to estimate a mapping rule.

Also, some other equipment other than the mapping rule estimation server 2100 may also conduct mapping rule estimation. In this case, the IPv6 equipment 1100 reports to some other equipment that “aaa.sample.com” resolved to 64:ff9b::0a01:0203, and that the IPv4 address of “aaa.sample.com” is 10.1.2.3, and that other equipment estimates a mapping rule.

Also, IPv6 address generation may also be conducted by the IPv4 equipment 2200 or some other equipment. In this case, the mapping rule of the IPv6 equipment 1100 is reported in advance to the other equipment that conducts address generation.

Also, although in the foregoing embodiment an FQDN lookup is conducted once when estimating a mapping rule (step S64 in FIG. 7), multiple attempts may be made in order to estimate a mapping rule. For example, by using multiple FQDNs for mapping rule estimation and acquiring respective IPv6 addresses with a prefix added to respective IPv4 addresses, the reliability of the mapping rule estimation may be improved. Also, even in the case of estimating on the basis of a single FQDN as in the foregoing embodiment, a mapping rule may be estimated by performing multiple FQDN lookups against a single FQDN and acquiring an IPv6 address with a prefix added to the IPv4 address from each lookup. In so doing, the reliability of the estimation may be improved.

Mapping rule estimation may be conducted according to the following timings. First, a mapping rule may be estimated when the IPv6 equipment 1100 sensing that the IPv6 equipment 1100 itself only possesses an IPv6 address. In this case, a mapping rule is estimated and recorded even when communication is not taking place.

Also, a mapping rule is estimated when the IPv6 equipment 1100 senses that the IPv6 equipment 1100 itself only possesses an IPv6 address, and that communication with an IPv4 address is going to take place. In this case, a mapping rule is estimated when communication involving an IPv4 address takes place.

Next, although it is optimal for a mapping rule to be saved by the IPv6 equipment 1100 in an environment that uses the mapping rule, some other equipment (such as the mapping rule estimation server 2100) may also save the mapping rule. In this case, the IPv6 equipment 1100 queries the mapping rule estimation server 2100 for a mapping rule every time P2P communication with the IPv4 equipment 2200 starts.

The content saving a mapping rule may be an estimation result stating “append IPv4 address (hexadecimal) to the prefix 64:ff9b::” as in the foregoing embodiment. Also, the content saving a mapping rule may also save only information stating “the IPv4 address (10.1.2.3) became the IPv6 address (64:ff9b::0a01:0203)”, with a mapping rule being estimated every time an address is generated.

Regarding the discarding and updating of a mapping rule, rather than being saved, a mapping rule may also be estimated every time as appropriate, such as when starting P2P communication. Furthermore, a mapping rule may be periodically monitored, and an existing mapping rule may be updated in the case of a change.

Also, in the case of a change in network conditions (such as sensing down/up of the IF), a mapping rule may be stored in only a volatile area for re-estimation, or stored in a non-volatile area (and refreshed according to the above change in conditions).

[7. Application to UDP (or TCP) Hole Punching]

With P2P communication, there exists technology in which both peers simultaneously connect on the basis of addresses acquired from an intermediary server, referred to as UDP (or TCP) hole punching. The content described in the foregoing embodiment and modifications may also be broadly applied to UDP hole punching.

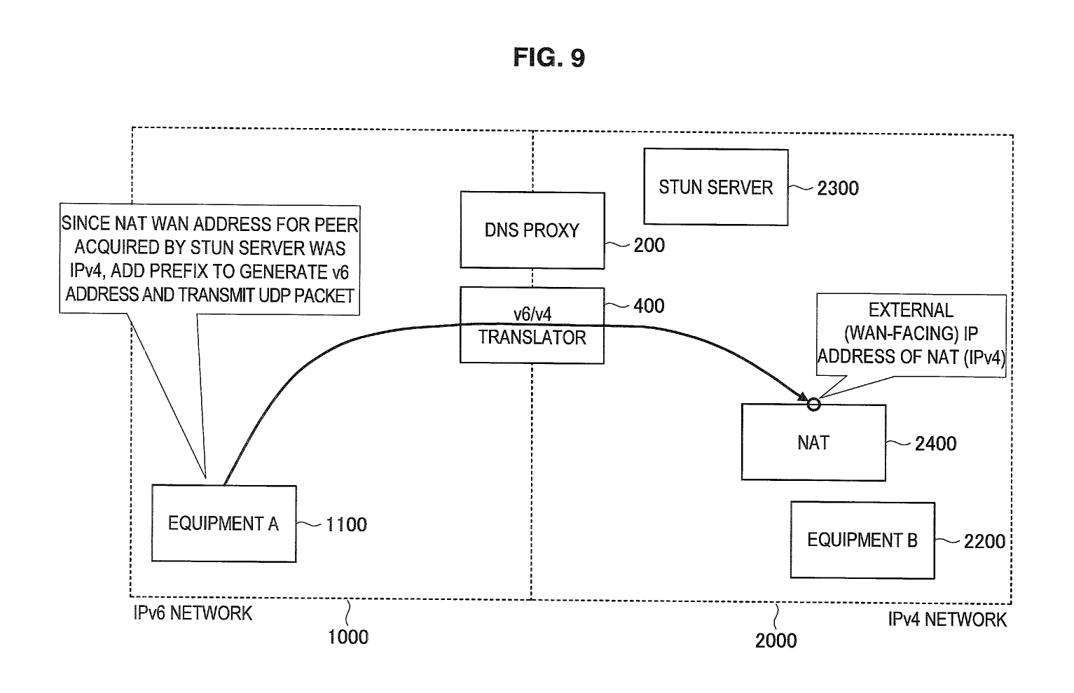

FIG. 9 is a schematic diagram illustrating an example of UDP hole punching. In the system illustrated in FIG. 9, IPv6 equipment 1100 belongs to a IPv6 network 1000. IPv4 equipment 2200, a STUN server 2300 that acts as an intermediary server, a NAT 2400, and a mapping rule estimation server 2100 belong to a IPv4 network 2000.

In the configuration illustrated in FIG. 9, the STUN server 2300 reports IP addresses for P2P communication to the IPv6 equipment 1100 and the IPv4 equipment 2200. At this point, since the NAT 2400 acts as a relay for the IPv4 equipment 2200 on the IPv4 network 2000, the STUN server 2300 reports the external (WAN-facing) IPv4 address of the NAT 2400 to the IPv6 equipment 1100.

Since the WAN address of the NAT 2400 for the peer acquired by the STUN server 2300 is an IPv4 address, the IPv6 equipment 1100 adds a prefix to generate an IPv6 address on the basis of a mapping rule, and then transmits a UDP packet.

According to the present embodiment as described above, it is possible to estimate, from an FQDN and an IPv4 address, a mapping rule from an IPv4 address to an IPv6 address. Subsequently, it is possible to change the IPv4 address into an IPv6 address on the basis of the estimated mapping rule, and make a connection. Consequently, in the case of conducting P2P communication, it becomes possible to greatly improve the likelihood of connectable communication peers. Also, with P2P technology that supports a server relay as a fallback, it becomes possible to reduce the load on the server, and improve the communication rate compared to a server relay.

It should be understood by those skilled in the art that various modifications, combinations, sub-combinations and alterations may occur depending on design requirements and other factors insofar as they are within the scope of the appended claims or the equivalents thereof

Additionally, the present technology may also be configured as below:
(1) An information processing device including:

a communication unit that transmits a domain name of a server belonging to a first network, and receives, from a mapping device that maps an IP address on a first network corresponding to the domain name to an IP address on a second network, an IP address on the second network that corresponds to the domain name;

an estimator that, from the IP address on the second network received by the communication unit and the IP address on the first network of the server, estimates a mapping rule that maps an IP address on the first network to an IP address on the second network; and

a generator that, on the basis of an estimated mapping rule, generates an IP address on the second network from an arbitrary IP address on the first network.
(2) The information processing device according to (1), wherein

the communication unit uses the IP address on the second network generated by the generator to conduct P2P communication with equipment on the first network.
(3) The information processing device according to (1), wherein

the IP address on the first network of the server is preregistered before product shipment.
(4) The information processing device according to (1), wherein

the IP address on the first network of the server is reported from the server via a translator.
(5) The information processing device according to (1), wherein

the IP address on the first network of the server is preregistered by being conveyed by an operator related to the server.
(6) The information processing device according to any one of (1) to (5), wherein

the communication unit transmits the domain name multiple times, and receives an IP address on the second network corresponding to the domain name multiple times, and

the estimator estimates the mapping rule from the IP address on the second network received by the communication unit multiple times, and the IP address on the first network of the server.
(7) The information processing device according to any one of (1) to (6), wherein

the communication unit transmits domain names of a plurality of servers belonging to a first network, and plurally receives an IP address on the second network corresponding to the domain names of the plurality of servers, and

the estimator estimates the mapping rule from the IP address on the second network plurally received by the communication unit, and the respective IP addresses on the first network of the plurality of servers.
(8) The information processing device according to any one of (1) to (7), wherein

the estimator estimates the mapping rule in a case of sensing that the information processing device possesses only an IP address on the second network.
(9) The information processing device according to any one of (1) to (7), wherein

the estimator estimates the mapping rule when communicating with equipment on a first network.
(10) The information processing device according to any one of (1) to (9), further including:

a recording unit that records the mapping rule.
(11) An information processing method including:

transmitting a domain name of a server belonging to a first network;

receiving, from a mapping device that maps an IP address on a first network corresponding to the domain name to an IP address on a second network, an IP address on the second network that corresponds to the domain name;

estimating, from the received IP address on the second network and the IP address on the first network of the server, a mapping rule that maps an IP address on the first network to an IP address on the second network; and

generating, on the basis of an estimated mapping rule, an IP address on the second network from an arbitrary IP address on the first network.
(12) An information processing system including:

a first device provided with an estimator that acquires an IP address in which an IP address on a first network corresponding to a domain name of a server belonging to a first network has been mapped to an IP address on a second network, and estimates, from the acquired IP address and the IP address on the first network of the server, a mapping rule that maps an IP address on the first network to an IP address on the second network; and

a second device provided with a generator that, on the basis of a mapping rule estimated by the first device, generates an IP address on the second network from an arbitrary IP address on the first network.

What is claimed is:

1. An information processing device comprising:
a communication unit that transmits a domain name of a server belonging to a first network, and receives, from a mapping device that maps an IP address on a first network corresponding to the domain name to an IP address on a second network, an IP address on the second network that corresponds to the domain name;
an estimator that, from the IP address on the second network received by the communication unit and the IP address on the first network of the server, estimates a mapping rule that maps an IP address on the first network to an IP address on the second network; and
a generator that, on the basis of an estimated mapping rule, generates an IP address on the second network from an arbitrary IP address on the first network.

2. The information processing device according to claim 1, wherein
the communication unit uses the IP address on the second network generated by the generator to conduct P2P communication with equipment on the first network.

3. The information processing device according to claim 1, wherein
the IP address on the first network of the server is preregistered before product shipment.

4. The information processing device according to claim 1, wherein
the IP address on the first network of the server is reported from the server via a translator.

5. The information processing device according to claim 1, wherein
the IP address on the first network of the server is preregistered by being conveyed by an operator related to the server.

6. The information processing device according to claim 1, wherein
the communication unit transmits the domain name multiple times, and receives an IP address on the second network corresponding to the domain name multiple times, and
the estimator estimates the mapping rule from the IP address on the second network received by the communication unit multiple times, and the IP address on the first network of the server.

7. The information processing device according to claim 1, wherein
the communication unit transmits domain names of a plurality of servers belonging to a first network, and plurally receives an IP address on the second network corresponding to the domain names of the plurality of servers, and
the estimator estimates the mapping rule from the IP address on the second network plurally received by the communication unit, and the respective IP addresses on the first network of the plurality of servers.

8. The information processing device according to claim 1, wherein
the estimator estimates the mapping rule in a case of sensing that the information processing device possesses only an IP address on the second network.

9. The information processing device according to claim 1, wherein
the estimator estimates the mapping rule when communicating with equipment on a first network.

10. The information processing device according to claim 1, further comprising:
a recording unit that records the mapping rule.

11. An information processing method comprising:
transmitting a domain name of a server belonging to a first network;
receiving, from a mapping device that maps an IP address on a first network corresponding to the domain name to an IP address on a second network, an IP address on the second network that corresponds to the domain name;
estimating, from the received IP address on the second network and the IP address on the first network of the server, a mapping rule that maps an IP address on the first network to an IP address on the second network; and
generating, on the basis of an estimated mapping rule, an IP address on the second network from an arbitrary IP address on the first network.

12. An information processing system comprising:
a first device provided with an estimator that acquires an IP address in which an IP address on a first network corresponding to a domain name of a server belonging to a first network has been mapped to an IP address on a second network, and estimates, from the acquired IP address and the IP address on the first network of the server, a mapping rule that maps an IP address on the first network to an IP address on the second network; and
a second device provided with a generator that, on the basis of a mapping rule estimated by the first device, generates an IP address on the second network from an arbitrary IP address on the first network.
